(19) United States
(12) Patent Application Publication
(10) Pub. No.: US 2023/0387740 A1
(43) Pub. Date: Nov. 30, 2023

(54) COOLING RING UNIT FOR AN ELECTRICAL MOTOR

(71) Applicant: Valeo eAutomotive Germany GmbH, Erlangen (DE)

(72) Inventors: Philipp SÖNTGERATH, Bad Neustadt a.d.Saale (DE); Nils KRAIS, Bad Neustadt a.d.Saale (DE)

(73) Assignee: Valeo eAutomotive Germany GmbH, Erlangen (DE)

(21) Appl. No.: 18/245,972

(22) PCT Filed: Sep. 20, 2021
(86) PCT No.: PCT/EP2021/075800

§ 371 Date: Mar. 20, 2023

(30) Foreign Application Priority Data
Oct. 21, 2020 (DE) 10 2020 127 657.5

(51) Int. Cl. H02K 3/24; H02K 5/20

(52) U.S. Cl. CPC H02K 3/24; H02K 5/20; H02K 2213/03

(57) ABSTRACT

A cooling ring unit having a hollow circular shape, configured to be integrated in an electric rotating machine includes a housing and at least one electrical component. The cooling ring unit includes at least one inlet, a plurality of outlets, and an annular body having a concave transverse section adapted to form an enclosed substantially annular volume with the housing of the electric rotating machine. The enclosed substantially annular volume forms a cooling circuit connecting the at least one inlet and the plurality of outlets. The enclosed substantially annular volume is configured to channel a coolant, the plurality of outlets being formed throughout said annular body, and the cooling ring unit being configured to project the coolant through the plurality of outlets in order to cool the at least one electrical component.

### FIELD OF THE INVENTION

The present invention belongs to the field of electric rotating machines configured to be on board of an automotive vehicle, such as an electric vehicle (EV) or a hybrid vehicle (HV).

The present invention relates in particular to the field of cooling systems integrated to electric rotating machines.

### BACKGROUND OF THE INVENTION

As is known, electric or a hybrid vehicles comprise electrical systems which require a cooling system, in order to ensure a proper in-service operation of said electrical systems. For example, the electric or the hybrid vehicles comprise an electrical motor, an inverter, a DC-DC converter, and an on-board charger, which all need to be cooled.

As is known too, electrical motors are configured to be supplied with a high voltage power supply battery via an on-board high voltage electrical network, and to deliver a mechanical power in order to ensure propulsion of the vehicle. This power transmission configuration is referred to as a mechanical power generation configuration. To some extent, electrical motors may also convert a mechanical power, for example provided by a braking action of the vehicle, onto an electric power further evacuated through the on-board high voltage electrical network. This power transmission configuration is referred as an electric power generation configuration.

In a general manner, an electrical motor comprises a stator comprising stator windings, referring to as a fixed part of the electrical motor, and a rotor, referring to a rotating part of the electrical motor. In the mechanical power generation configuration, the stator windings are configured to be supplied with an alternating current (AC) electrical energy and to produce a stator rotating magnetic field. The rotor comprises a rotor shaft driven by the rotation of the rotor and configured to ensure the transmission of the mechanical power between the electrical motor and an exterior driven apparatus.

Regarding electrical motors in general, heat loss is a limiting factor when targeting higher power levels, which underlines the importance of the cooling system requirements. Hence, the cooling system requirements are integrated early in a design process of electrical motors. More specifically, the main components of the electrical motor which need to be efficiently cooled are the rotor shaft, a rotor core, and the stator windings.

As is known, windings are in general made out of copper. When a high level of current passes through the windings, it generates heat loss that may lead to the thermal failure of the windings. Moreover, the stator windings have a hollow cylindrical shape comprising two circular flat ends and an outer curved circumference. Then, the stator windings are cooled both through the two circular flat ends, designated as windings ends, and through the outer curved circumference.

In a general manner, the cooling system of the windings ends consists in a conventional cooling spraying system. The conventional cooling spraying system comprises a plurality of nozzle units directed towards the windings ends and configured to channel and to spray a coolant towards the winding ends. Most frequently, the coolant is oil.

An uneven flow distribution of the coolant favors a generation of local areas having higher levels of temperature compared to a mean temperature of the windings ends. Those local areas are designated as hot spots. The hot-spots may induce a premature failure of the copper material composing the stator windings.

Conventional cooling spraying systems are difficult to design with the constraint of producing an even flow distribution. Moreover, conventional cooling spraying systems are cumbersome, which has an impact on the capacity of electrical motors.

### SUMMARY OF THE INVENTION

In accordance with the present invention a cooling ring unit configured to be integrated in an electric rotating machine comprising at least one electric component needing to be cooled, is provided. The electric rotating machine comprises a housing, a rotor and a stator comprising two windings ends. The cooling ring unit is configured to cool the at least one electrical component, preferably either one of the two windings ends, designated as a windings end.

The cooling ring unit makes it possible to generate an even flow distribution of a coolant towards the windings end. Thus, the present invention prevents from the apparition of hot-spots in the windings end. Hot-spots are local areas having higher levels of temperature compared to a mean temperature. Consequently, the present invention improves a service life of the electric rotating machine by reducing a risk of thermal failure of the windings end.

The cooling ring unit has a hollow circular shape adapted for the coolant to fully reach the windings end. The cooling ring unit comprises at least one inlet, a plurality of outlets, and an annular body. The annular body has a concave transverse section adapted to form an enclosed substantially annular volume with the housing. The enclosed substantially annular volume forms a cooling circuit connecting the at least one inlet and the plurality of outlets. The plurality of outlets passes through the annular body.

The enclosed substantially annular volume is configured to channel the coolant from the at least one inlet towards the plurality of outlets. Then, the plurality of outlets is configured to project the coolant towards the windings end.

Advantageously, the annular body comprises a protruding annular portion comprising the plurality of outlets.

Advantageously, the protruding annular portion comprises an inner face oriented inward of the concave transverse section, and an outer face oriented outward of the concave transverse section.

Advantageously, the outer face of the protruding annular portion is configured to face a front face of the windings end. The outer face of the protruding annular portion forms preferably with the front face a first angle of attack of the protruding annular portion substantially equal to 45 degrees. The first angle of attack at 45 degrees allows to target in an optimal manner the front face.

Advantageously, the annular body may comprise three portions, a first annular portion, the protruding annular portion, and a second annular portion. The protruding annular portion is in-between the first annular portion and the second annular portion. Hence, the protruding annular portion contributes mainly to the orientation of the coolant towards the windings end. The first and the second annular portions mainly contribute to forming the cooling circuit with the housing and to ensure a mounting of the cooling ring unit in the housing.

According to a first embodiment of the invention, the first annular portion, the protruding annular portion, and the second annular portion have a U-shape section. In the first embodiment of the invention, the first annular portion and the second annular portion are parallel to one another. Then, the protruding annular portion forms an obtuse angle with the first annular portion such that the first angle of attack may be set substantially equal to 45 degrees. The first and the second annular portions are, in an advantageous manner, configured to be both mounted on a lateral housing face of the housing.

According to a second embodiment of the invention, the first and the second annular portions are configured to be mounted respectively on distinct faces of the housing. For instance, the first and the second annular portions are configured to be mounted respectively on the lateral housing face and on a front housing face of the housing.

Advantageously, the at least one inlet is protruding from the annular body and is adapted to inlet the coolant from an external cooling circuit.

Advantageously, the at least one inlet has an upward position with respect to the electric rotating machine, in order for the coolant to benefit from gravity. Hence, pumping requirements upstream of the cooling ring unit are reduced.

Advantageously, the plurality of outlets comprises bores. Each one of the bores has a cylindrical shape having an axis. The axis of each one of the bores is oriented such that it forms with the front face, a second angle of attack substantially equal to 45 degrees. Thus, each one of the bores is oriented in an optimal manner towards the windings end.

Advantageously, the bores have a same diameter and a same length. The same diameter is, in an advantageous manner, within the range 0.4 mm and 2 mm, and is preferably equal to 1 mm. The same length, which correspond to a thickness of the protruding annular portion, lie in a preferred manner within the range 1 mm and 3 mm.

Advantageously, the plurality of outlets is distributed regularly along the protruding annular portion in order to ensure an even distribution of the coolant on the windings end.

Advantageously, the cooling ring unit comprises a clamping system configured to allow the clamping of the cooling ring unit to the housing.

Advantageously, the electric rotating machine comprises the rotor, the stator comprising the two windings ends, the housing and a first and a second cooling ring units. The first and the second cooling ring units are each configured to cool respectively one and the other one of the two windings ends.

One aspect of the invention is an electric drive comprising an inverter configured to convert a dc-voltage into an ac voltage and the inventive electric rotating machine driven by the inverter, in particular by the ac voltage generated by the inverter. The ac voltage may be a multiphase ac voltage, in particular a three-phase voltage.

A further aspect of the invention is a vehicle comprising the electric drive for driving the vehicle.

Advantageously, a material constituting the cooling ring unit is a non-magnetic and a non-electric conductive material, preferably a plastic material. Advantageously, the plastic material is a thermoplastic material, preferably a polyamide such as an unreinforced PA66 with flame-retarding supplement. The use of the non-magnetic and the non-electric conductive material allows reducing a clearance distance requirement between the cooling ring unit and the windings end. Hence, a reduced clearance distance makes it possible to reduce the size of the housing and thus the related cost, and to increase the capacity of the electric rotating machine.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

The invention will be better understood on reading the description that follows, and by referring to the appended drawings given as non-limiting examples, in which identical references are given to similar objects and in which:

FIG. 1 illustrates a cooling ring unit according to a first embodiment of the invention;

FIG. 2 illustrates a cross-sectional view of an electric rotating machine comprising a first and a second cooling ring units according to a second embodiment of the invention;

FIG. 3 illustrates a front view of the electric rotating machine;

FIG. 4 illustrates an enlarged partial cross-sectional view of the electric rotating machine comprising a cooling ring unit according to the second embodiment the invention;

FIG. 5 illustrates an enlarged partial cross-sectional view of the electric rotating machine comprising the cooling ring unit according to the first embodiment the invention.

### DETAILED DESCRIPTION

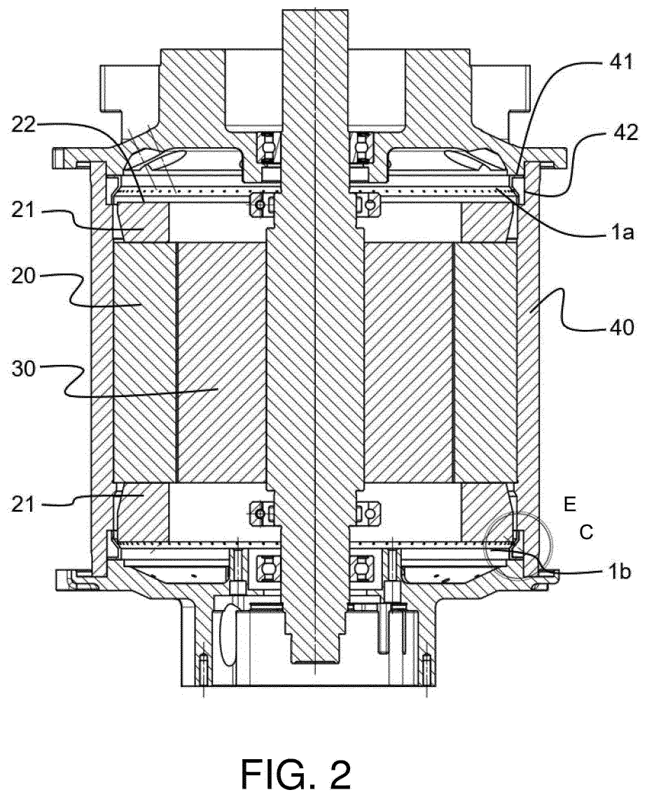

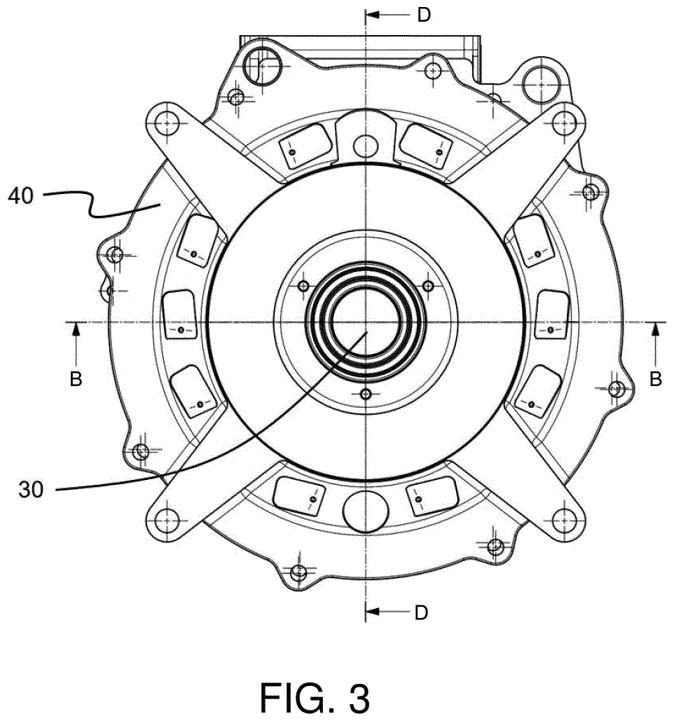

The invention relates to a cooling ring unit configured to be integrated in an electric rotating machine comprising a housing and at least one electrical component, and to cool the at least one electrical component. In reference to FIGS. 2 and 3, the electric rotating machine comprises a rotor 30 referring to a rotating part of the electric rotating machine, a stator 20 referring to a fixed part of the electrical motor, and the housing 40. The stator 20 comprises two windings ends 21 having to be cooled.

In reference to FIGS. 2 and 3, the present invention will be described hereafter in a context of the cooling ring unit (1a or 1b) adapted for its mounting in the housing 40 of the electric rotating machine of an electric or a hybrid vehicle. In this context, the cooling ring unit (1a or 1b) is configured to cool the at least one electrical component corresponding to either one of the two windings ends 21, designated as a windings end, without limiting the scope of the present invention.

Hereafter is provided a general description of the invention.

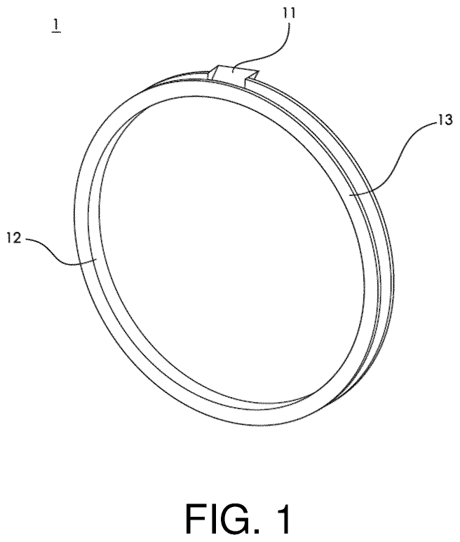

FIG. 1 illustrates the cooling ring unit 1 according to a first embodiment of the invention. The cooling ring unit 1 has a hollow circular shape adapted for the coolant to fully reach the windings end. The cooling ring unit 1 comprises at least one inlet 11, a plurality of outlets 12, and an annular body 13.

The annular body 13 has a concave transverse section adapted to form an enclosed substantially annular volume with the housing 40 of the electric rotating machine.

The enclosed substantially annular volume forms a cooling circuit connecting the at least one inlet 11 and the plurality of outlets 12. The cooling circuit is configured to channel the coolant, preferably an oil.

The plurality of outlets 12 passes through the annular body 13.

The enclosed substantially annular volume is configured to channel the coolant from the at least one inlet 11 towards the plurality of outlets 12. Then, the plurality of outlets 12 is configured to project the coolant towards the windings end.

The annular body 13 is detailed hereafter.

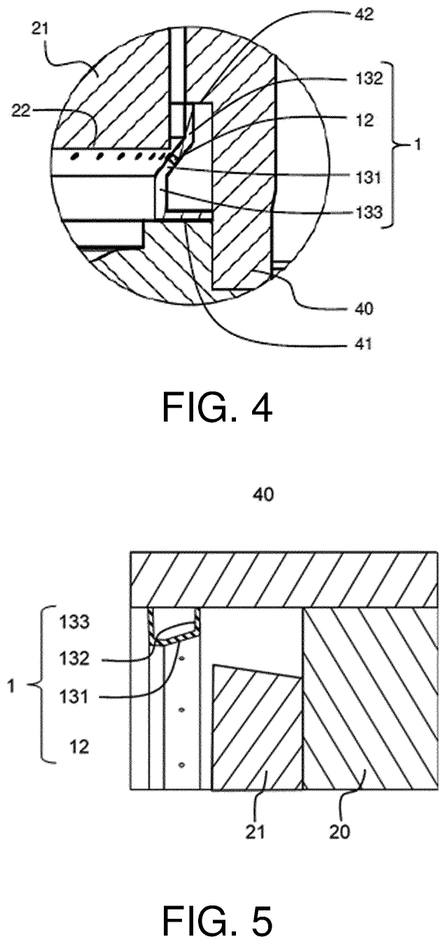

Advantageously, in reference to FIGS. 4 and 5, the annular body 13 comprises a protruding annular portion 131 comprising the plurality of outlets 12.

Advantageously, the protruding annular portion 131 comprises an inner face oriented inward of the concave transverse section, and an outer face oriented outward of the concave transverse section. Preferably, the inner face and/or the outer face of the protruding annular portion 131 are plane.

Advantageously, the windings end comprises a front face 22. Then, the outer face of the protruding annular portion 131 is configured to face the front face 22. Preferably, the outer face of the protruding annular portion 131 forms with the front face 22 a first angle of attack of the protruding annular portion 131 substantially equal to 45 degrees. This positioning facilitates the direction of the plurality of outlets 12 towards the windings end.

Advantageously, in reference to FIGS. 4 and 5, a first annular portion 132, the protruding annular portion 131, and a second annular portion 133 form the annular body 13. In other words, the annular body 13 may comprise three portions, the first annular portion 132, the protruding annular portion 131, and the second annular portion 133. The protruding annular portion 131 is directly connected on one end to the first annular portion 132 and on another end to the second annular portion 133. In other words, the protruding annular portion 131 is in-between the first annular portion 132 and the second annular portion 133. Hence, the protruding annular portion 131 contributes mainly to the orientation of the coolant towards the windings end. The first 132 and the second 133 annular portions mainly contribute to forming the cooling circuit with the housing 40 and to ensure a mounting of the cooling ring unit 1 in the housing 40.

According to the first embodiment of the invention, in reference to FIG. 5, the first annular portion 132, the protruding annular portion 131, and the second annular portion 133 have a U-shape section. In the first embodiment of the invention, the first annular portion 132 is parallel to the second annular portion 133. Moreover, the protruding annular portion 131 forms an obtuse angle with the first annular portion 132 such that the first angle of attack may be set substantially equal to 45 degrees. The obtuse angle is preferably 135 degrees. The first 132 and the second 133 annular portions are configured to be both mounted on a lateral housing face 42 of the housing 40.

According to a second embodiment of the invention, in reference to FIG. 4, the first annular portion 132 is adapted for its mounting on the lateral housing face 42 of the housing 40. Furthermore, in the second embodiment of the invention, the second annular portion 133 is adapted for its mounting on a front housing face 41 of the housing 40. In other words, the first (132) and the second (133) annular portions are configured to be mounted respectively on distinct faces of the housing (40).

The first 132 and the second 133 annular portions are not limited to previously described embodiments, provided that they allow the outer face of the protruding annular portion 131 to face the front face 22 with the first angle of attack substantially equal to 45 degrees. The embodiments of the first 132 and of the second 133 annular portions mostly depend on a mounting method of the cooling ring unit 1 in the housing 40.

Advantageously, a material constituting the cooling ring unit 1 is a non-magnetic and a non-electric conductive material, preferably a plastic material. Advantageously, the plastic material is a thermoplastic material, preferably a polyamide such as an unreinforced PA66 with flame-retarding supplement. The use of the non-magnetic and the non-electric conductive material allows reducing a clearance distance requirement between the cooling ring unit 1 and the windings end. The respect of the clearance distance requirement allows to avoid a perturbation of the windings end by an electromagnetic interference phenomenon. Furthermore, a reduced clearance distance makes it possible to reduce the size of the housing 40 and thus the related cost, and to increase the capacity of the electric rotating machine.

The inlet 11 is detailed hereafter.

Advantageously, in reference to FIG. 1, the at least one inlet 11 is protruding from the annular body 13 and is adapted to inlet the coolant inward the cooling ring unit 1 from an external cooling circuit.

Advantageously, the at least one inlet 11 has an upward position with respect to the electric rotating machine, in order for the coolant to benefit from gravity. Hence, pumping requirements upstream of the cooling ring unit 1 are reduced.

The plurality of outlets 12 are detailed hereafter.

Advantageously, in reference to FIG. 4, the plurality of outlets 12 comprises bores. Each one of the bores has a cylindrical shape having an axis.

Advantageously, the axis of each one of the bores is oriented such that it forms with the front face 22, a second angle of attack substantially equal to 45 degrees.

Advantageously, the bores have a same diameter and a same length. The same diameter lie in a preferred manner within the range 0.4 mm and 2 mm, and are preferably equal to 1 mm. The same length, which correspond to a thickness of the protruding annular portion 131, lie in a preferred manner within the range 1 mm and 3 mm.

Advantageously, the bores 12 are distributed regularly along the protruding annular portion 131 in order to ensure an even distribution of the coolant on the windings end. There are preferably ninety bores 12.

The mounting method of the cooling ring unit 1 in the housing 40 is detailed hereafter.

Advantageously, the cooling ring unit 1 is configured to be glued to the housing 40 of the electric rotating machine.

Alternatively, the cooling ring unit 1 may comprise a clamping system configured to allow the clamping of the cooling ring unit 1 to the housing 40 of the electric rotating machine. According to the second embodiment of the invention presented beforehand, in reference to FIG. 4, the first annular portion 132 is mounted on the lateral housing face 42 and the second annular portion 133 is mounted on the front housing face 41. In the second embodiment of the invention, the cooling ring unit 1 is clamped between a lateral element of the housing 40 and an end shield of the housing 40.

Hereafter is provided a description of an embodiment of the electric rotating machine as represented in FIGS. 2 and 3, comprising a first 1a and a second 1b cooling ring units. An embodiment of the first cooling ring 1a unit may differ from an embodiment of the second cooling ring unit 1b.

As presented before, the electric rotating machine comprises the rotor 30, the stator 20 comprising the two windings ends 21, and the housing 40. In an advantageous manner, the first 1a and the second 1b cooling ring units are each adapted for its mounting in the housing 40 and to cool respectively one and the other one of the two windings ends 21.

Although embodiments have been described with reference to a number of illustrative embodiments thereof, it should be understood that numerous other modifications and embodiments can be devised by those skilled in the art that will fall within the spirit and scope of the principles of this disclosure.

The technical advantages of the present invention will now be detailed.

In a nutshell, the present invention provides the cooling ring unit configured to be integrated in the electric rotating machine comprising the housing and the at least one electrical component.

The present invention has a thermal advantage compared to a conventional cooling spraying system. The present invention allows the generation of an even flow distribution of the coolant which is projected through all the plurality of outlets. Thus, the present invention prevents from the apparition of hot-spots in the at least one electrical component, for example the windings end, leading to a possible premature thermal failure of the windings end.

In an advantageous manner, the present invention offers a substantial flexibility in a design and in a manufacturing methods.

Regarding the design method, the number, the diameters, the lengths, and the axes of the bores are easily adjustable, in order to achieve the wanted level of thermal efficiency.

Regarding the manufacturing method, the present invention offers the possibility of a late mounting stage during the manufacturing of the electric rotating machine.

Advantageously, the present invention contributes to a cost efficiency of the electric rotating machine. Being independent from the housing of the electric rotating machine, the present invention may consist in a cheaper material than the housing, for example a plastic material.

Moreover, in an advantageous manner, the use of a non-magnetic and/or non-electric conductive material for the present invention reduces a clearance distance between the cooling ring unit and the windings end. Thus, the present invention allows saving space and requires a smaller housing compared to cooling solutions using magnetic and/or electric conductive materials. Hence, the present invention contributes to the cost efficiency, to reduce the weight, and to increase the capacity of the electric rotating machine.

The electrical rotating machine is in particular an electric motor and may be a part of an electric drive which comprises, in addition to the electrical rotating machine, an inverter configured to convert a dc-voltage provided, for instance, by a battery into an ac voltage. The ac voltage is in particular a three phase voltage and is intended to drive the electric rotating machine. The electric drive may be used to drive a vehicle.

1. A cooling ring unit having a hollow circular shape, configured to be integrated in an electric rotating machine comprising a housing and at least one electrical component, said cooling ring unit comprising:
at least one inlet,
a plurality of outlets,
an annular body having a concave transverse section adapted to form an enclosed substantially annular volume with said housing of said electric rotating machine,
said enclosed substantially annular volume forming a cooling circuit connecting said at least one inlet and said plurality of outlets, said enclosed substantially annular volume being configured to channel a coolant,
said plurality of outlets being formed throughout said annular body, and said cooling ring unit being configured to project the coolant through said plurality of outlets in order to cool said at least one electrical component of said electric rotating machine.

2. The cooling ring unit as claimed in claim 1, wherein said annular body comprises a protruding annular portion comprising said plurality of outlets.

3. The cooling ring unit as claimed in claim 2, wherein said protruding annular portion comprises an inner face oriented inward of said concave transverse section, and an outer face oriented outward of said concave transverse section.

4. The cooling ring unit as claimed in claim 3, wherein said outer face of said protruding annular portion is configured to face a front face of said at least one electrical component, said outer face of said protruding annular portion
forming with said front face first angle of attack of the protruding annular portion substantially equal to 45 degrees.

5. The cooling ring unit as claimed in claim 2, wherein a first annular portion, said protruding annular portion and a second annular portion form said annular body, wherein said protruding annular portion is directly connected on one end to said first annular portion and on another end to said second annular portion.

6. The cooling ring unit as claimed in claim 5, wherein said first annular portion, said protruding annular portion, and said second annular portion
has a U-shape section, wherein said first annular portion is parallel to said second annular portion, said protruding annular portion forming an obtuse angle with said first annular portion, said first and said second annular portions being configured to be mounted on a lateral housing face of said housing.

7. The cooling ring unit as claimed in claim 5, wherein said first annular portion is configured to be mounted on said lateral housing face of said housing, said second annular portion being configured to be mounted on a front housing face of said housing.

8. The cooling ring unit as claimed in claim 1, wherein said at least one inlet is protruding from said annular body, said at least one inlet being adapted to inlet the coolant inward the cooling ring unit from an external cooling circuit.

9. The cooling ring unit as claimed in claim 1, wherein said plurality of outlets comprises bores, each one of the bores having a cylindrical shape having an axis, each axis of each one of the bores being directed such that it forms with said front face, a second angle of attack substantially equal to 45 degrees.

10. The cooling ring unit as claimed in claim 9, wherein the bores have a same diameter, the same diameter is within the range 0.4 mm and 2 mm, and is preferably equal to 1 mm.

11. The cooling ring unit as claimed in claim 1, wherein said plurality of outlets is distributed regularly along said protruding annular portion.

12. The cooling ring unit as claimed in claim 1, wherein it comprises a clamping system configured to allow the clamping of said cooling ring unit to said housing of said electric rotating machine.

13. An electric rotating machine comprising a rotor, a stator comprising two windings ends, the housing, and a first and a second cooling ring units as claimed in claim 1, said first and said second cooling ring units each being configured to cool respectively one and the other one of said two windings ends.

14. The cooling ring unit as claimed in claim 3, wherein a first annular portion, said protruding annular portion and a second annular portion form said annular body, wherein said protruding annular portion is directly connected on one end to said first annular portion and on another end to said second annular portion.

15. The cooling ring unit as claimed in claim 4, wherein a first annular portion, said protruding annular portion and a second annular portion form said annular body, wherein said protruding annular portion is directly connected on one end to said first annular portion and on another end to said second annular portion.

16. The cooling ring unit as claimed in claim 2, wherein said at least one inlet is protruding from said annular body, said at least one inlet being adapted to inlet the coolant inward the cooling ring unit from an external cooling circuit.

17. The cooling ring unit as claimed in claim 2, wherein said plurality of outlets comprises bores, each one of the bores having a cylindrical shape having an axis, each axis of each one of the bores being directed such that it forms with said front face, a second angle of attack substantially equal to 45 degrees.

18. The cooling ring unit as claimed in claim 2, wherein said plurality of outlets is distributed regularly along said protruding annular portion.

19. The cooling ring unit as claimed in claim 2, wherein it comprises a clamping system configured to allow the clamping of said cooling ring unit to said housing of said electric rotating machine.

20. An electric rotating machine comprising a rotor, a stator comprising two windings ends, the housing, and a first and a second cooling ring units as claimed in claim 2, said first and said second cooling ring units each being configured to cool respectively one and the other one of said two windings ends.
